(19) United States
(12) Patent Application Publication
(10) Pub. No.: US 2005/0114678 A1
(43) Pub. Date: May 26, 2005

(54) Method and apparatus for verifying security of authentication information extracted from a user

(76) Inventors: Amit Bagga, Green Brook, NJ (US); Jon Bentley, New Providence, NJ (US); Lawrence O'Gorman, Madison, NJ (US); Kiyoshi Sudo, Forest Hills, NY (US)

Correspondence Address: Ryan, Mason & Lewis, LLP, Suite 205, 1300 Post Road, Fairfield, CT, 06824, US

(21) Appl. No.: 10/815,191

(22) Filed: Mar. 31, 2004

Related U.S. Application Data
(63) Continuation-in-part of application No. 10/723,416, filed on Nov. 26, 2003.

(51) Int. Cl. H04K 1/00

(52) U.S. Cl. 713/183

(57) ABSTRACT

A method and apparatus are provided for evaluating the security of authentication information that is extracted from a user. The disclosed authentication information security analysis techniques determine whether extracted authentication information can be obtained by an attacker. The extracted authentication information might be, for example, personal identification numbers (PINs), passwords and query based passwords (questions and answers). A disclosed authentication information security analysis process employs information extraction techniques to verify that the authentication information provided by a user is not easily obtained through an online search. The authentication information security analysis process measures the security of authentication information, such as query based passwords, provided by a user. Information extraction techniques are employed to find and report relations between the proposed password and certain user information that might make the proposed password vulnerable to attack.

### CROSS-REFERENCE TO RELATED APPLICATIONS

The present application is a continuation-in-part of U.S. patent application Ser. No. 10/723,416, filed Nov. 26, 2003, entitled “Method and Apparatus for Extracting Authentication Information from a User,” incorporated by reference herein.

### FIELD OF THE INVENTION

The present invention relates generally to user authentication techniques and more particularly, to methods and apparatus for generating user passwords.

### BACKGROUND OF THE INVENTION

Most computers and computer networks incorporate computer security techniques, such as access control mechanisms, to prevent unauthorized users from accessing remote resources. Human authentication is the process of verifying the identity of a user in a computer system, often as a prerequisite to allowing access to resources in the system. A number of authentication protocols have been proposed or suggested to prevent the unauthorized access of remote resources. In one variation, each user has a password that is presumably known only to the authorized user and to the authenticating host. Before accessing the remote resource, the user must provide the appropriate password, to prove his or her authority.

Generally, a good password is easy for the user to remember, yet not easily guessed by an attacker. In order to improve the security of passwords, the number of login attempts is often limited (to prevent an attacker from guessing a password) and users are often required to change their password periodically. Some systems use simple methods such as minimum password length, prohibition of dictionary words and techniques to evaluate a user-selected password at the time the password is selected, to ensure that the password is not particularly susceptible to being guessed. As a result, users are often prevented from using passwords that are easily recalled. In addition, many systems generate random passwords that users are required to use.

In a call center environment, users are often authenticated using traditional query directed authentication techniques by asking them personal questions, such as their social security number, date of birth or mother's maiden name. The query can be thought of as a hint to “pull” a fact from a user's long term memory. As such, the answer need not be memorized. Although convenient, traditional authentication protocols based on queries are not particularly secure.

U.S. patent application Ser. No. 10/723,416, entitled “Method and Apparatus for Extracting Authentication Information from a User,” improves the security of such authentication protocols by extracting information from a user's memory that will be easily recalled by the user during future authentication yet is hard for an attacker to guess. The information might be a little-known fact of personal relevance to the user (such as an old telephone number) or the personal details surrounding a public event (such as the user's environment on Sep. 11, 2001) or a private event (such as an accomplishment of the user). Users are guided to appropriate topics and information extraction techniques are employed to verify that the information is not easily attacked and to estimate how many bits of assurance the question and answer provide. A need exists for methods and apparatus that evaluate the security of authentication information that is extracted from a user. A further need exists for information extraction techniques that verify whether extracted authentication information can be easily obtained by an attacker.

### SUMMARY OF THE INVENTION

Generally, a method and apparatus are provided for evaluating the security of authentication information that is extracted from a user. The disclosed authentication information security analysis techniques determine whether extracted authentication information can be obtained by an attacker. The extracted authentication information might be, for example, personal identification numbers (PINs), passwords and query based passwords (questions and answers).

According to one aspect of the invention, a disclosed authentication information security analysis process employs information extraction techniques to verify that the authentication information provided by a user is not easily obtained through an online search. Generally, the authentication information security analysis process measures the security of authentication information, such as query based passwords, provided by a user. Information extraction techniques are employed to find and report relations between the proposed password and certain user information that might make the proposed password vulnerable to attack.

In one exemplary implementation, three exemplary rule classes are employed to determine whether a proposed password may be obtained by an attacker. A first class of rules, referred to as “self association rules,” determines whether a proposed answer is associated with the user. A second class of rules, referred to as “hint association rules,” determines whether a proposed answer is associated with a proposed hint in a particular relation. For example, the information extraction techniques performed according to the hint association rules can determine, if there is a predefined relationship between the owner of a telephone number and the user, such as a family member (self, sibling or parent), co-author, teammate, colleague or member of the same household or community. A third class of rules, referred to as “commonality rules,” determines whether the proposed answer is so common that it is easily guessed from the proposed hint.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram illustrating the password enrollment/verification server of FIG. 1 in further detail;

FIG. 3 is a sample table from an exemplary user database of FIGS. 1 and 2;

FIG. 4 is a flow chart describing an exemplary implementation of an enrollment process of FIG. 2 incorporating features of the present invention;

FIG. 5 is a flow chart describing an exemplary implementation of a verification process of FIG. 2 incorporating features of the present invention;

FIG. 6 is an exemplary user interface that presents a user with a set of topics from which the user can select a given topic for which the user will provide one or more answers;

FIG. 7 is an exemplary user interface that presents the user with a set of sub-topics from which the user can select a given topic for which the user will provide one or more answers;

FIG. 8 is an exemplary user interface that allows a user to enter a proposed answer for evaluation;

FIG. 9 is an exemplary user interface that allows a user to enter a proposed reminder or hint associated with a particular answer for evaluation;

FIGS. 10 and 11 are exemplary dialog boxes that present a user with information if a proposed password is rejected;

FIG. 12 is an exemplary user interface that presents the selected answer and reminder to the user and optionally allows the user to specify whether periodic reminders should be sent;

FIG. 13 illustrates the relationship between the user information, proposed answer and proposed hint that can be tested by the present invention for various relations that render the proposed password vulnerable to attack;

FIG. 14 illustrates a “self association rule” that determine whether a proposed answer is associated with user information;

FIG. 15 illustrates a “hint association rule” that determines whether the proposed answer is associated with the proposed hint in a particular relation;

FIG. 16 illustrates a “commonality rule” that determines whether the proposed answer is easily guessed from the proposed hint;

FIG. 17 is a flow chart describing an exemplary implementation of an authentication information security analysis process that incorporates features of the present invention;

FIG. 18 is a sample table from an exemplary authentication information security analysis rule-base that incorporates features of the present invention; and

FIG. 19 illustrates exemplary word counts from a search engine for certain words that can be analyzed according to the present invention to identify certain words that are highly correlated with certain users.

### DETAILED DESCRIPTION

The present invention provides methods and apparatus that evaluate the security of authentication information that is extracted from a user. The authentication information might be, for example, personal identification numbers (PINs), passwords and query based passwords (questions and answers). According to one aspect of the invention, an authentication information security analysis process 1700 employs information extraction techniques to verify that the authentication information provided by a user is not easily searchable. Generally, the authentication information security analysis process 1700 measures the security of authentication information, such as query based passwords, provided by a user. The present invention assumes that the authentication information is provided by a cooperative user trying to generate a strong password (e.g., a proposed secret and hint in a query based password implementation). The authentication information security analysis process 1700 employs information extraction techniques to find and report relations between the proposed password and certain user information that might make the proposed password vulnerable to attack.

While the present invention is illustrated using authentication information based on numbers, such as telephone numbers, street addresses, post office numbers, Zip codes, dates (such as birthdays, anniversaries, and significant events), identification numbers (such as employee, membership, or social security numbers), physical statistics (such as height or weight) or monetary amounts, the present invention also applies to other forms of authentication information, as would be apparent to a person of ordinary skill in the art. For example, as discussed below, the present invention can be applied to evaluate the security of authentication information based on names, such as names of people or streets, or other textual information, such as automobile license plate numbers. Furthermore, while the present invention is illustrated using an exemplary query based password implementation, the present invention also applies to implementations that employ PINs and other passwords.

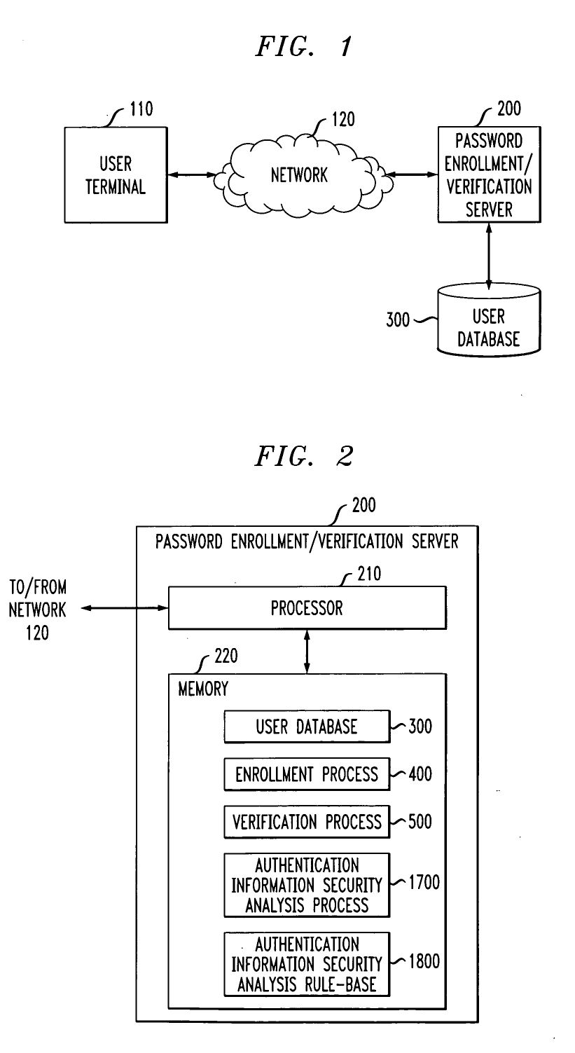

The exemplary authentication scheme of the present invention works with a user to define a question having an easily remembered answer that is not easily guessed by another person. In one implementation, a password enrollment/verification server 200, discussed further below in conjunction with FIG. 2, first guides a user to provide a good answer during an enrollment phase and then to provide a corresponding good question that will be used as a hint to the user during a subsequent verification phase. Generally, the user is guided to provide an answer within a topic area that is broad enough to apply to many users, yet narrow enough so that a given answer can be evaluated on the basis of how easily the answer may be guessed, given the question or information about the user (or both). In addition, the topics should be selected to be sufficiently private so the answers are hard to guess, yet not be so private that a user is not comfortable sharing the facts. For example, the present invention recognizes that for many users, numbers, such as telephone numbers, addresses, dates, identifying numbers or numerical facts, or textual facts, such as names of people or streets, are easy for a user to remember, yet are not easily guessed by an attacker. In addition, numbers or facts related to the personal history of the user may be easily remembered, yet not easily discovered by others.

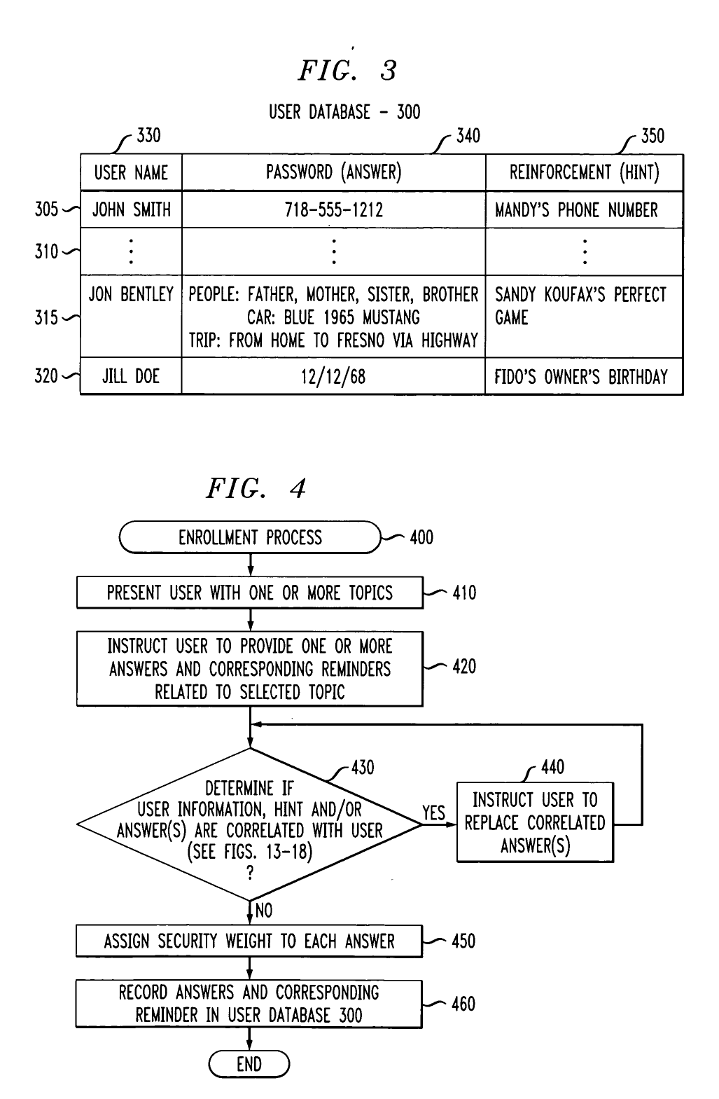

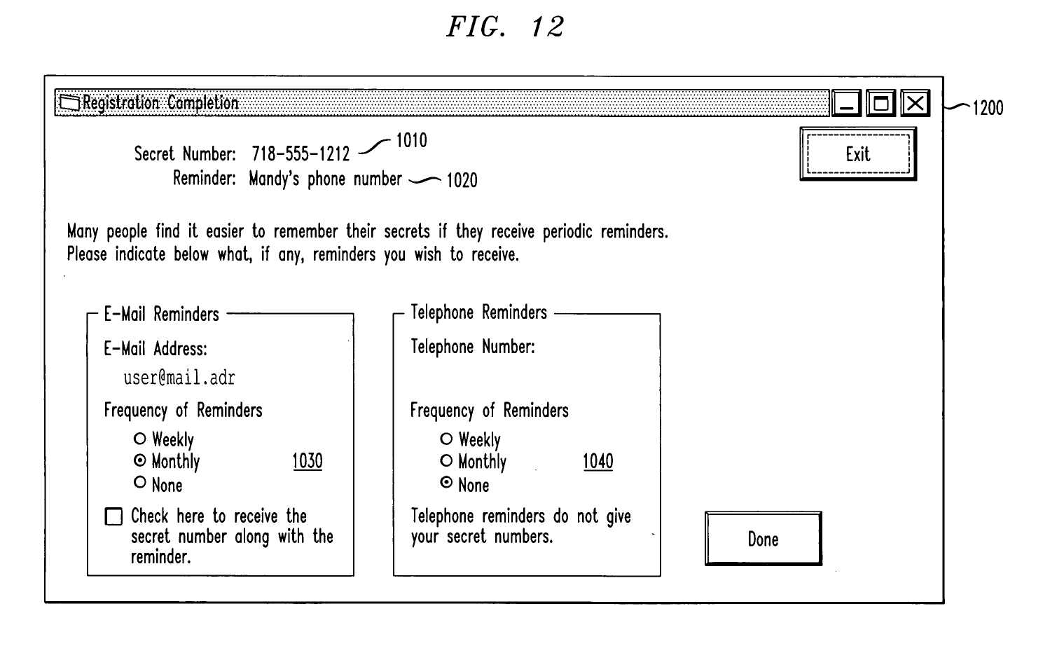

Information extraction techniques are employed during the enrollment phase to verify the security of the questions and answers provided by the user. As discussed further below in conjunction with FIGS. 13 through 18, the information extraction techniques evaluate whether the provided questions and answers can be qualitatively or quantitatively correlated with the user by a potential attacker. Generally, the information extraction techniques evaluate whether (or the extent to which) a given answer can be correlated with a given user by performing an online or curriculum vitae search of any correlated material between the user and the answer. For example, if a user selects a telephone number of a person, the information extraction techniques determine if there is a predefined relationship between the owner of the telephone number and the user, such as a family member (self, sibling or parent), co-author, colleague or member of the same household. If so, this telephone number is said to be correlated with the user and is disallowed as an answer. As another example, if a user selects the jersey number of a sports figure and the information extraction techniques reveal that the user is a fan of the sports team on which the sports figure stars, then that selection would be disallowed. This correlation may be quantitatively weighted, such that if correlations within a predefined threshold are found, the answer may still be allowed, however, if many correlations exceeding the predefined threshold are found, then the answer is disallowed. Such correlation information may be implemented as one or more correlation rules that are evaluated during the enrollment phase, as discussed further below in conjunction with FIG. 4.

FIG. 1 illustrates a network environment in which the present invention can operate. As shown in FIG. 1, a user employing a user device 110 attempts to access a remote protected resource over a network 120. In order to access the protected resource, such as a hardware device or bank account, the user must present an appropriate password. The user password is generated during an enrollment phase by a password enrollment/verification server 200, discussed further below in conjunction with FIG. 2. The network(s) 120 may be any combination of wired or wireless networks, such as the Internet and the Public Switched Telephone Network (PSTN). The password enrollment/verification server 200 may be associated, for example, with a call center or web server. It is noted that the present invention also applies in a stand-alone mode, for example, to control access to a given personal computer. Thus, in such an embodiment, the password enrollment/verification server 200 would be integrated with the user device 110. It is also noted that the password generation and authentication functions performed by the password enrollment/verification server 200 can be performed by two distinct computing systems.

As previously indicated, the user is guided during an enrollment phase to provide answers that are easy for the user to remember, but are not easily guessed by an attacker. In addition, during a verification phase, when the user attempts to access a resource that is protected using the present invention, the password enrollment/verification server 200 challenges the user with one or more questions that the user has previously answered, as recorded in a user database 300, discussed further below in conjunction with FIG. 3.

FIG. 2 is a schematic block diagram of an exemplary password enrollment/verification server 200 incorporating features of the present invention. The password enrollment/verification server 200 may be any computing device, such as a personal computer, work station or server. As shown in FIG. 2, the exemplary password enrollment/verification server 200 includes a processor 210 and a memory 220, in addition to other conventional elements (not shown). The processor 210 operates in conjunction with the memory 220 to execute one or more software programs. Such programs may be stored in memory 220 or another storage device accessible to the password enrollment/verification server 200 and executed by the processor 210 in a conventional manner.

For example, as discussed below in conjunction with FIGS. 3 through 5, the memory 220 may store a user database 300, an enrollment process 400 and a verification process 500. Generally, the user database 300 records the password that was generated for each enrolled user. The enrollment process 400 guides the user to provide one or more answers and evaluates whether the answers are correlated with the user. The verification process 500 employs a query directed password protocol incorporating features of the present invention to authenticate a user.

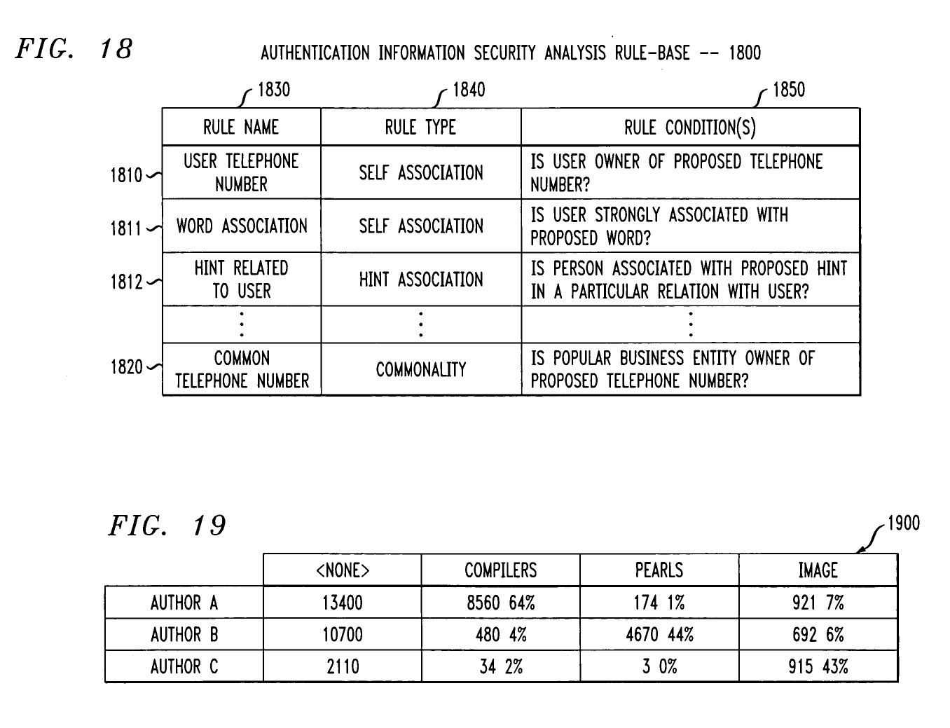

In addition, as discussed below in conjunction with FIGS. 17 and 18, respectively, the memory 220 may store an authentication information security analysis process 1700 and an authentication information security analysis rule-base 1800. Generally, the authentication information security analysis process 1700 employs information extraction techniques to verify that the authentication information provided by a user is not easily searchable using one or more predefined rules from the authentication information security analysis rule-base 1800.

FIG. 3 is a sample table from an exemplary user database 300 of FIGS. 1 and 2. The user database 300 records the query based password for each enrolled user. As shown in FIG. 3, the user database 300 consists of a plurality of records, such as records 305-320, each associated with a different enrolled user. For each enrolled user, the user database 300 identifies the user in field 330, as well as the password (answer) in field 340 and optionally provides an associated reinforcement (hint) in field 350. For example, the user indicated in record 305 may have provided the following telephone number as an answer 718-555-1212, and the corresponding hint “Mandy's Phone Number,” where Mandy may be, for example, a pet or a child, but not the person who is identified with the telephone number in a directory. Generally, the user will be allowed to user the selected telephone number as a password, provided that the information extraction analysis does not determine that the answer is correlated with the user, as discussed below in conjunction with FIG. 4.

FIG. 4 is a flow chart describing an exemplary implementation of an enrollment process 400 of FIG. 2 incorporating features of the present invention. As previously indicated, the exemplary enrollment process 400 guides the user to provide one or more answers and evaluates whether the answers are correlated with the user. As shown in FIG. 4, a user is initially presented with one or more topics (and optionally sub-topics) for selection during step 410. As previously indicated, the user can be guided to provide an answer within a topic area that is broad enough to apply to many users, yet narrow enough so that a given answer can be evaluated on the basis of how easily the answer may be guessed, given the question or information about the user (or both). In addition, the topics should be selected to be sufficiently private so the answers are hard to guess, yet not be so private that a user is not comfortable sharing the facts. The user is instructed during step 420 to provide one or more answers and associated reminders that are related to the selected topic.

A test is performed during step 430 to determine if the answers or reminders (or both) are correlated with the user, discussed below in conjunction with FIGS. 13 through 18. In one implementation, one or more correlation rules may be defined to evaluate whether a given answer is correlated with the user. For example, if a user selects a telephone number of a person, the information extraction analysis performed during step 430 can determine if there is a predefined relationship between the owner of the telephone number and the user, such as a family member (self, sibling or parent), co-author, colleague or member of the same household (qualitative correlation rule). The analysis correlates the number to the person by analyzing the number of hits obtained by using a search engine (such as Google.com or Orkut.com) where both the person and number appear on the same page. If the number of hits is higher than a chosen threshold, then a positive correlation is said to exist. Alternatively, the information extraction analysis may also use specialized web databases such as www.anywho.com that allow retrieval of information associated with a particular telephone number. The metric in this case is a positive match between the user's answer and the match against the phone entry.

If it is determined during step 430 that at least one answer or reminder (or both) can be correlated with the user, then these answers are discarded during step 440 and the user is requested to select additional answers. If, however, it is determined during step 430 that the answers or reminders (or both) cannot be correlated with the user (for example, according to some predefined criteria), then a weight is assigned to each selected question during step 450 to estimate the level of difficulty an attacker would have to answer the question correctly. Generally, the weights are inversely related to the probability of an answer being chosen by a wide population of users. For instance, consider a multiple choice question regarding favorite foods, with the following possible answers: 1) steak, 2) liver, 3) ice cream, 4) corn, 4) chicken, 6) rutabaga. Let us say that in a sampling of the population, people chose these answers in the following respective proportions: 1) 30%, 2) 3%, 3) 40%, 4) 10%, 4) 14%, 6) 2%. Because ice cream and steak could be guessed by an attacker as more likely than liver and rutabaga to be the answer of a user, the system gives less weight to these more popular answers. One way to weight these answers is by the inverse of the probability, so the weights here would be: 1) 3.33, 2) 33.3, 3) 2.4, 4) 10, 4) 6.6, 6) 40.

The selected questions, and corresponding weights and answers are recorded in the user database 300 during step 460 before program control terminates.

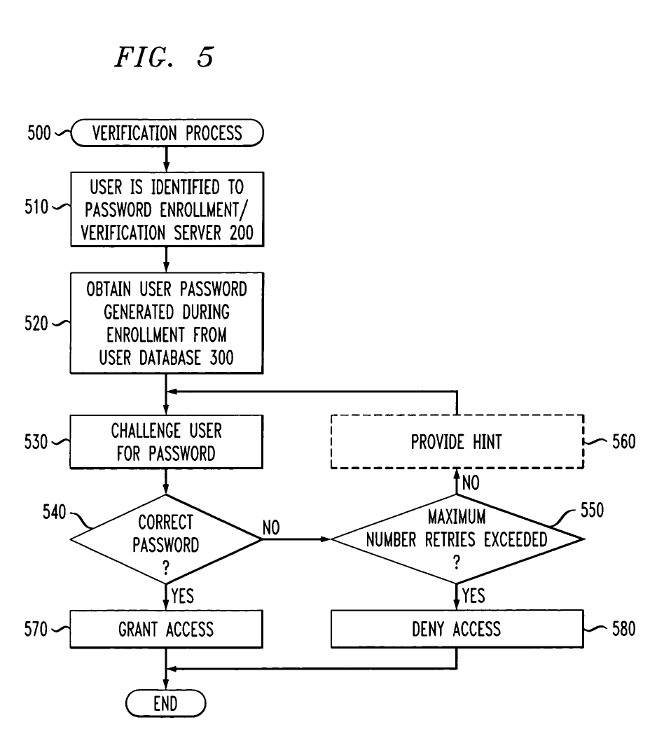

FIG. 5 is a flow chart describing an exemplary implementation of the verification process 500 of FIG. 2 incorporating features of the present invention. As previously indicated, the verification process 500 employs a query directed password protocol incorporating features of the present invention to authenticate a user. As shown in FIG. 5, the user initially identifies himself (or herself) to the password enrollment/verification server 200 during step 510. During step 520, the verification process 500 obtains the user password that was generated for this user during the enrollment phase from the user database 200. The user is challenged for the password during step 530. The challenge may optionally include the hint associated with the password.

A test is performed during step 540 to determine if the password provided by the user matches the password obtained from the user database 200. If it is determined during step 540 that the passwords do not match, then a further test is performed during step 550 to determine if the maximum number of retry attempts has been exceeded. If it is determined during step 550 that the maximum number of retry attempts has not been exceeded, then the user can optionally be presented with a hint during step 560 before again being challenged for the password. If it was determined during step 550 that the maximum number of retry attempts has been exceeded, then the user is denied access during step 580.

If, however, it was determined during step 540 that the password provided by the user matches the password obtained from the user database 200, then the user is provided with access during step 570.

Provision of Answers Related to a Selected Topic

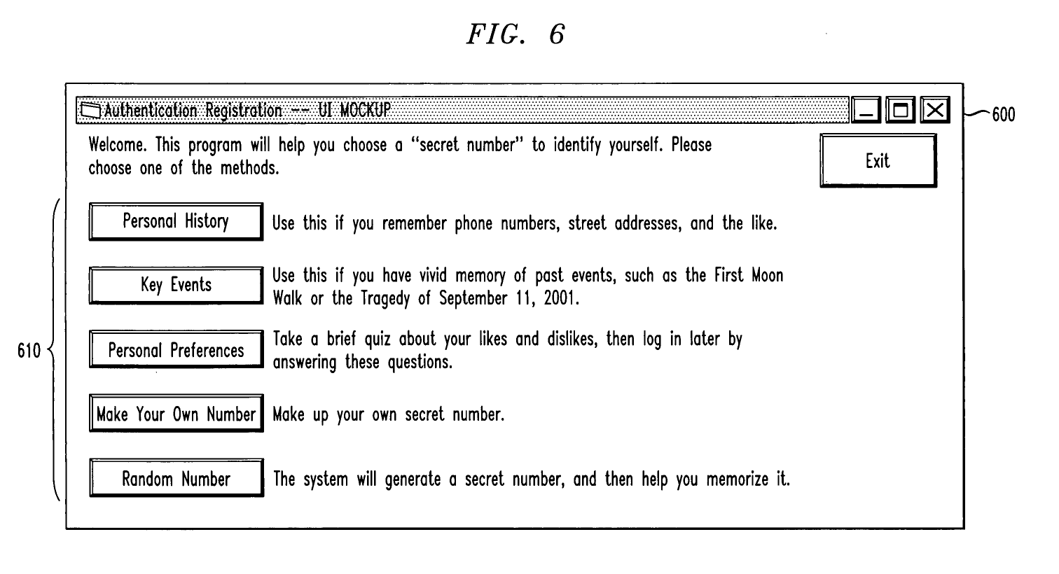

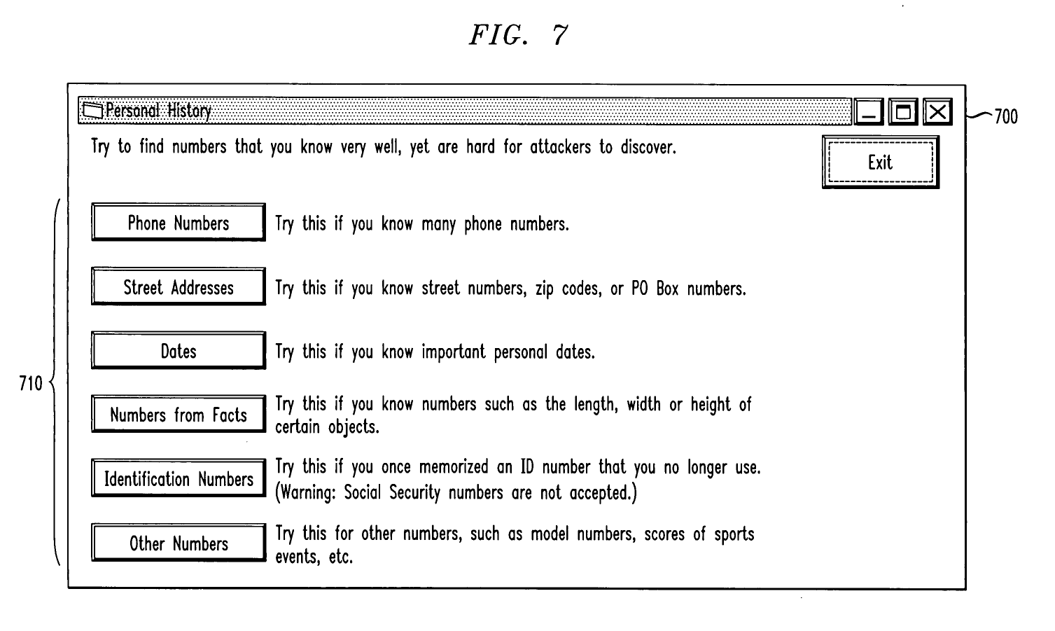

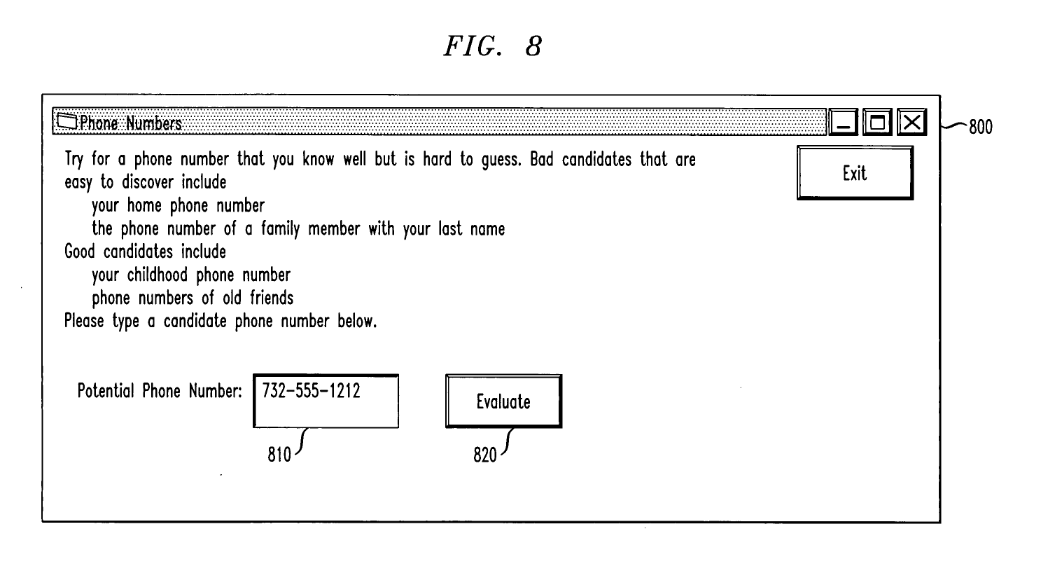

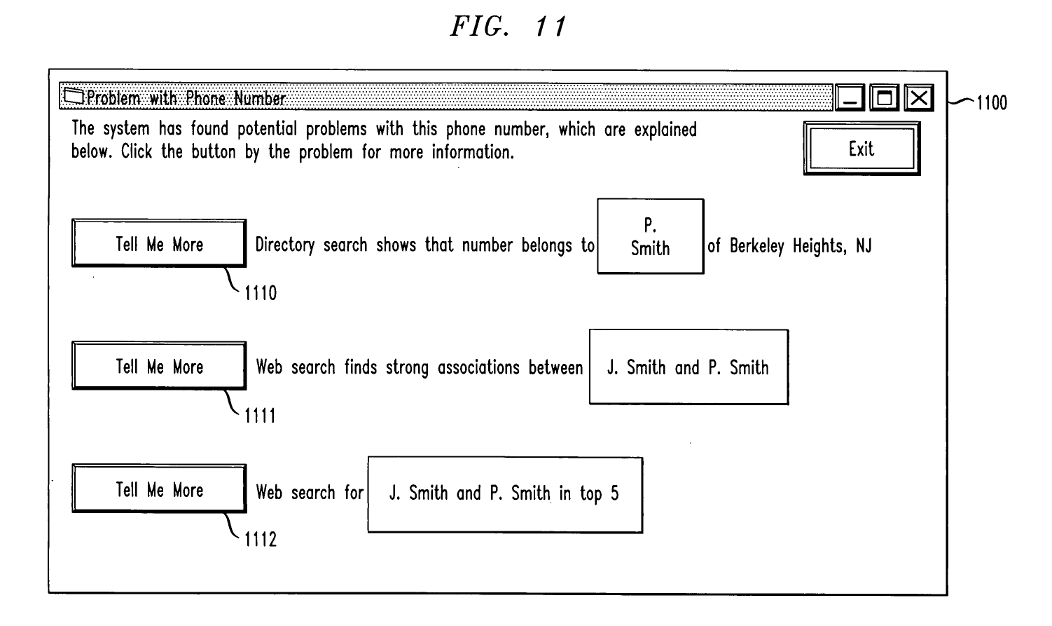

FIG. 6 is an exemplary user interface 600 that presents a user with a set of topics 610 (during step 410 of the enrollment process 400) from which the user can select a given topic for which the user will provide one or more answers. For example, the exemplary user interface 600 allows a user to select topics related to personal history, discussed below in conjunction with FIGS. 7 through 10, key events, discussed below in conjunction with FIGS. 11 through 15, personal preferences, make your own number, or a random number.

In an exemplary implementation, if a user selects the first topic (personal history) from the set of topics 610, then the user will be presented with the user interface 700, shown in FIG. 7. FIG. 7 is an exemplary user interface 700 that presents the user with a set of sub-topics 710 from which the user can select a given topic for which the user will provide one or more answers. As shown in FIG. 7, the exemplary interface 700 allows a user to provide answers that are related to telephone numbers, street addresses, dates, numbers from facts, identifying numbers, or other numbers.

In an exemplary implementation, if a user selects the first subtopic (telephone numbers) from the set of sub-topics 710, then the user will be presented with the user interface 800, shown in FIG. 8. FIG. 8 is an exemplary user interface 800 that allows a user to enter a proposed answer for evaluation in a field 810 and hit a button 820 to have the answer evaluated, as discussed further below. The interface 800 may optionally provide a user with guidelines or suggestions for good or bad answers. For example, the interface 800 may indicate that some bad choices include the telephone number of the user or another family member. Thus, a user can enter a candidate answer and receive feedback about whether the candidate answer is correlated with the user. For example, a reverse telephone look-up can be performed to determine if the telephone number is associated with the user or another person having one or more defined relations to the user, such as a family member or colleague. In addition, frequently used telephone numbers, such as those associated with large corporations or institutions, such as United Air Lines or the White House, can also be flagged as problematic.

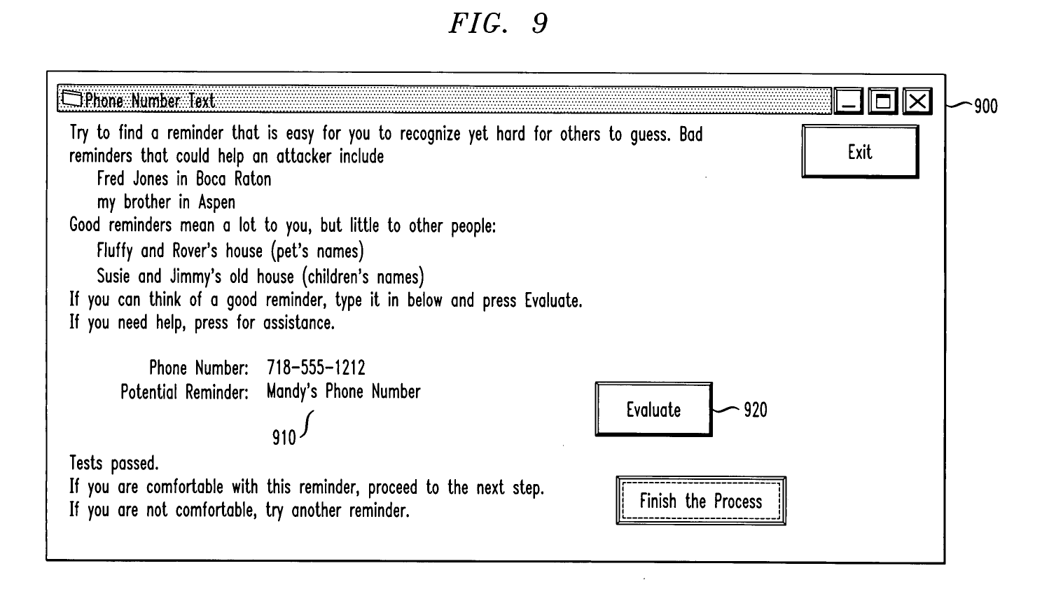

FIG. 9 is an exemplary user interface 900 that allows a user to enter a proposed reminder or hint associated with a particular answer in a field 910 and hit a button 920 to have the reminder evaluated, as discussed below. Just like a proposed answer, a proposed reminder can be evaluated using information extraction techniques. The interface 900 may optionally provide a user with guidelines or suggestions for good or bad reminders. For example, the interface 900 may indicate that some bad choices include the name and address of a particular person (whether identified explicitly by name or by a unique label that can be resolved by an attacker, such as “my mother”). Thus, a user can enter a candidate reminder and receive feedback about whether the candidate reminder is correlated with the user or the answer. For example, a search can be performed in a telephone directory to obtain the telephone number or address (or both) of a person identified in the proposed reminder to determine if the identified person is correlated with the user or the answer. In further variations, the proposed reminder may be presented by the user at login, stored by the user or memorized by the user.

It is noted that the proposed answer entered by the user using the interface 800 of FIG. 8 can optionally be evaluated and confirmed before the user is requested to enter a proposed reminder using the interface 900 of FIG. 9. If the user clicks on the button 820, or 920 to have the proposed answer or reminder evaluated, the authentication information security analysis process 1700 will be initiated to evaluate the proposed answer, reminder or both.

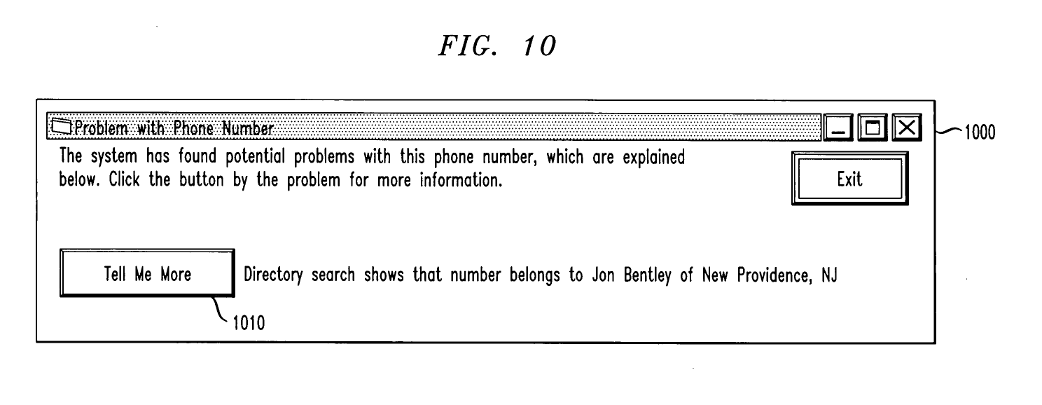

FIG. 10 is an exemplary dialog box 1000 that can be presented to a user if the authentication information security analysis process 1700 determines that the proposed telephone number might be vulnerable to attack. The interface 1000 can optionally include a button 1010 that allows the user to obtain additional information regarding the reasons why the proposed telephone number was rejected.

FIG. 11 illustrates an alternate embodiment for a dialog box 1100 that can present additional information to a user if the authentication information security analysis process 1700 determines that the proposed telephone number might be vulnerable to attack. The interface 1100 can optionally include one or more buttons 1110-1112 that allows the user to selectively obtain additional information for each of the reasons why the proposed telephone number was rejected. For example, a first button 1110 can provide additional information providing details of a directory search indicating that a proposed telephone number is associated with a person of a given relation (e.g., a family member). A second button 1111 can provide additional information providing details of a directory search indicating that a proposed telephone number indicates strong associations between the user and the person associated with the proposed telephone number (e.g., a family member). Finally, a third button 1112 can provide additional information providing details of a directory search indicating that the person associated with the telephone number was in the “top N” results for a web search for the name of the user.

Upon a successful evaluation by the authentication information security analysis process 1700, an exemplary user interface 1200, shown in FIG. 12, can present the selected answer and reminder to the user and optionally allow the user to specify, for example, upon completion of an enrollment, whether reminders should be sent. The exemplary interface 1200 presents the user with an answer in a field 1210 and the corresponding reminder in a field 1220. The user can optionally specify whether any reminders should be sent by electronic mail or telephone, and the frequency of such reminders, using fields 1230, 1240, respectively.

Verifying Security of Extracted Authentication Information

As previously indicated, the present invention provides methods and apparatus that evaluate the security of authentication information extracted from a user. The present invention employs information extraction techniques to find and report relations between the proposed password and certain user information that might make the proposed password vulnerable to attack. In the exemplary query based password implementation, a query based password is comprised of a proposed hint and a proposed answer. Thus, the present invention will assess and report any relations between the proposed hint, proposed answer and user information.

FIG. 13 illustrates the relationship between the user information 1310, proposed answer 1320 and proposed hint 1320 that can be tested by the present invention for various relations that render the proposed password vulnerable to attack. As shown in FIG. 13, an exemplary user, John Smith, has associated user information 1310, that may be obtained, for example, from the user database 300 that records a password generated for each enrolled user and other user information, such as an address (not shown). The authentication information security analysis process 1700 can optionally interact with the user to collect additional user information 1310. The user has interacted with the password enrollment/verification server 200 of FIG. 2 using the interfaces 800, 900 of FIGS. 8 and 9, to enter a proposed answer 1320 and a proposed hint (reminder) 1330.

The types of hints 1330 and user background information 1310 are strongly related to the kind of secret that are employed for authentication. For example, when the spectrum of hints are highly constrained, the searches performed to asses the hint are easier. In an implementation where the user has greater flexibility in entering hints (i.e., where the user is allowed to be more expressive and thus the hints may be more useful), however, the searches become more challenging. Similarly, when the authentication information security analysis process 1700 has richer user background information 1310 available, the security assessment can be more comprehensive, but takes greater time.

In the exemplary embodiment, where telephone numbers are used as query based passwords, the telephone number of the user can be obtained from a number of databases, including web sites, such as anywho.com, that provide a telephone number given name or address information (or both), or can provide a name or address information (or both) given a telephone number. In addition, depending on the application, proprietary databases, such as an employee directory, may be available to provide additional information.

As discussed further below in conjunction with FIGS. 17 and 18, the exemplary authentication information security analysis process 1700 employs an authentication information security analysis rule-base 1800, shown in FIG. 18. The rules stored in the authentication information security analysis rule-base 1800 provide a flexible mechanism for the authentication information security analysis process 1700 to assess various predefined security vulnerabilities associated with each rule.

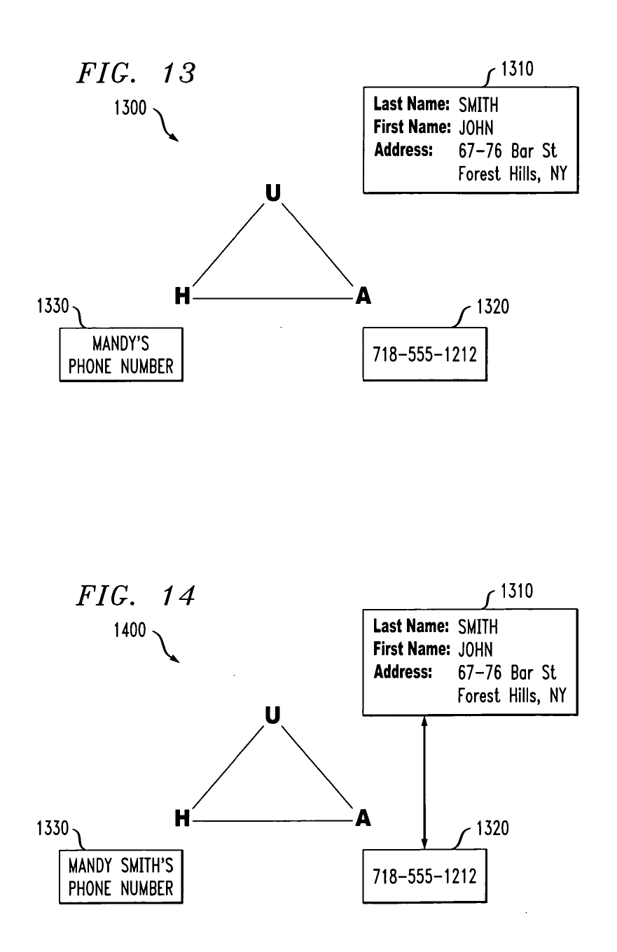

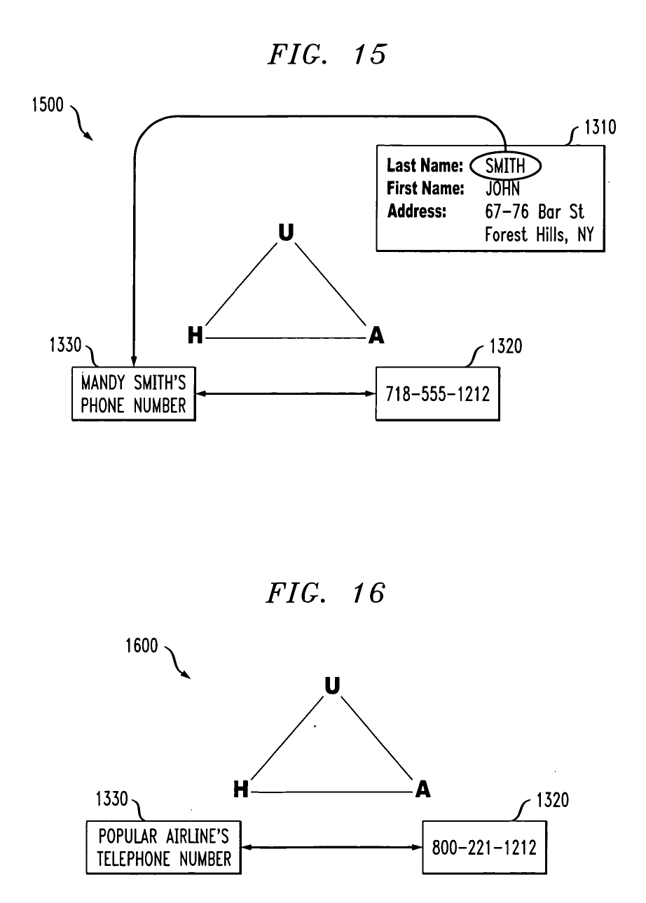

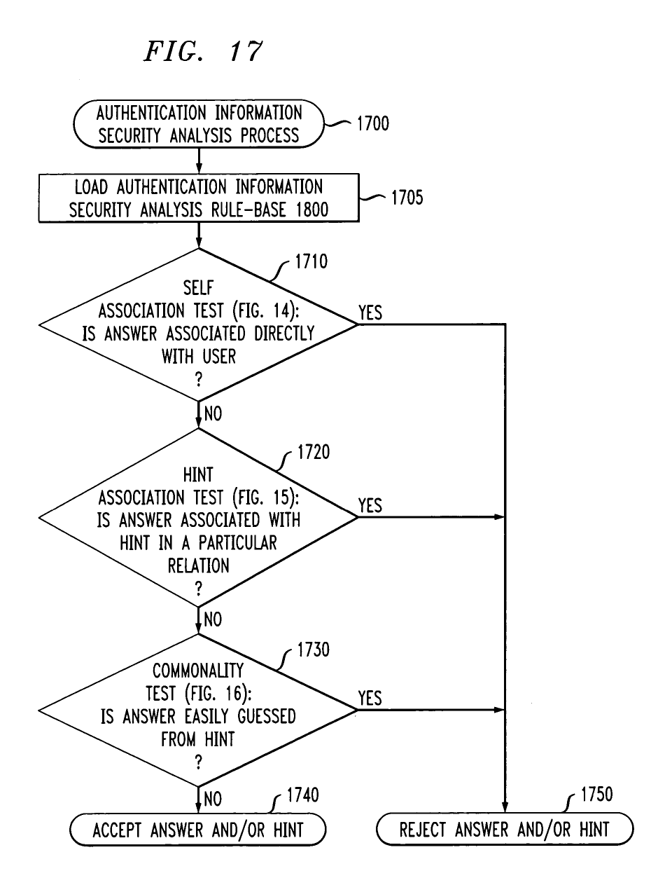

In the illustrative embodiment, the rules stored in the authentication information security analysis rule-base 1800 may generally be classified into one of three exemplary rule classes. A first class of rules, referred to as “self association rules,” illustrated in FIG. 14, determine whether the proposed answer 1320 is associated with the user information 1310. As shown in FIG. 14, the exemplary self association rule 1400 determines whether the user 1310 is the owner of the telephone number that was entered as a proposed answer 1320. If so, this telephone number is said to be correlated with the user and is disallowed as an answer.

A second class of rules, referred to as “hint association rules,” illustrated in FIG. 15, determine whether the proposed answer 1320 is associated with the proposed hint 1330 in a particular relation. As shown in FIG. 15, the exemplary hint association rule 1500 determines whether the person associated with the proposed hint 1330 is in a particular relation with the user 1310. For example, the information extraction techniques performed according to the hint association rules can determine, for example, if there is a predefined relationship between the owner of the telephone number and the user, such as a family member (self, sibling or parent), co-author, colleague or member of the same household. If so, this telephone number is said to be correlated with the user and is disallowed as an answer. For example, the hint association rule 1500 can determine whether the user 1310 is related to the owner of the telephone number that was entered as a proposed answer 1320. For example, the proposed answer can be searched using a reverse telephone lookup, such as anywho.com, and the resulting name can be compared to the user name for a family relation (i.e., whether the owner of the telephone number and the user have the same last name) or neighbor relation (i.e., whether the owner of the telephone number and the user live on the same street or within a specified distance).

A third class of rules, referred to as “commonality rules,” illustrated in FIG. 16, determine whether the proposed answer 1320 is easily guessed from the proposed hint 1330. As shown in FIG. 16, the exemplary commonality rule 1600 determines whether a popular business entity is the owner of the telephone number that was entered as a proposed answer 1320. If so, this telephone number is said to be easily guessed and is disallowed as an answer. Examples of information that is easily guessed includes the height of Mount Fuji, the telephone number of a popular business and the number on a jersey of a popular professional athlete.

As previously indicated, during a verification process, the user is presented with a reminder or hint that the user provided during an enrollment process. The user must then enter the corresponding answer that the user provided during enrollment, in order to obtain access to the requested device or resource. Thus, it can be assumed that an attacker has access to the user information 1310 and reminder 1330. The present invention employs information extraction techniques to simulate the activities of an attacker and try to determine whether the proposed answer 1320 can be easily obtained from either the user information 1310 or reminder 1330. If the present invention can find a correlation through an online search between either the user information or the reminder and the proposed answer, the proposed answer should be rejected. The online search may be performed, for example, using a search engine, such as Google.com.

For example, the online search may employ a query comprised of a given user name and proposed answer. The documents that satisfy the query can be evaluated to determine if there is an association between the user name and answer.

FIG. 17 is a flow chart describing an exemplary implementation of an authentication information security analysis process 1700 that employs information extraction techniques to verify that the authentication information provided by a user is not easily searchable. Generally, the authentication information security analysis process 1700 measures the security of authentication information, such as query based passwords, provided by a user. One challenge, of course is how to measure the “security” of a question in a query based password implementation.

The authentication information security analysis process 1700 is illustrated using authentication information based on telephone numbers. As previously indicated, the authentication information security analysis process 1700 can be extended to assess the security of other numbers, such as street addresses, post office numbers, Zip codes, dates (such as birthdays, anniversaries, and significant events) identification numbers (such as employee or membership numbers), physical statistics (such as height or weight) or monetary amounts, as well as other forms of authentication information, as would be apparent to a person of ordinary skill in the art.

As shown in FIG. 17, the authentication information security analysis process 1700 initially loads the authentication information security analysis rule-base 1800, discussed further below in conjunction with FIG. 18, during step 1705. As previously indicated, the rules stored in the authentication information security analysis rule-base 1800 provide a flexible mechanism for the authentication information security analysis process 1700 to assess various predefined security vulnerabilities associated with each rule. In the illustrative embodiment, the authentication information security analysis process 1700 loads three exemplary rules from the authentication information security analysis rule-base 1800 that are tested by the authentication information security analysis process 1700. The three exemplary rules are each associated with one of the three exemplary rule classes. Thus, exemplary self association, hint association and commonlity rules are tested during steps 1710, 1720 and 1730, respectively. The authentication information security analysis process 1700 can assess additional rules from the authentication information security analysis rule-base 1800, discussed below, as would be apparent to a person of ordinary skill.

A self association test is performed during step 1710 to determine whether the proposed answer is associated directly with the user. If it is determined during step 1710 that the proposed answer is associated directly with user, the proposed answer is said to be correlated with the user and is disallowed as an answer. Program control thus proceeds to step 1750, discussed below.

A hint association test is performed during step 1720 to determine whether the proposed answer is associated with the proposed hint in a particular relation, such as a family member (self, sibling or parent), co-author, teammates, colleagues or members of the same household or community. If it is determined during step 1720 that the proposed answer is associated with the proposed hint, the proposed hint is said to be correlated with the user and is disallowed as an answer. Program control thus proceeds to step 1750, discussed below.

A commonality test is performed during step 1730 to determine whether the proposed answer is easily guessed from the proposed hint. If it is determined during step 1730 that the proposed answer is easily guessed from the proposed hint, the proposed answer and proposed hint are disallowed as a query based passwords. Program control thus proceeds to step 1750, discussed below.

If each of the exemplary tests performed during steps 1710, 1720 and 1730 pass, program control will proceed to step 1740 where the proposed answer and/or hint are accepted. Upon a successful evaluation by the authentication information security analysis process 1700, the exemplary user interface 1200 of FIG. 12 can present the selected answer and reminder to the user and optionally allow the user to specify whether reminders should be sent.

If any of the exemplary tests performed during steps 1710, 1720 and 1730 fail, program control will proceed to step 1750 where the proposed answer and/or hint are rejected. When the authentication information security analysis process 1700 determines that the proposed answer and/or hint might be vulnerable to attack, one of the exemplary user interfaces 1000 or 1100 of FIGS. 10 and 11 can present the user with additional information regarding the reasons why the proposed password was rejected.

### Improving Search Results

The present invention employs information extraction techniques to simulate the activities of an attacker and try to determine whether the proposed answer 1320 can be easily obtained from either the user information 1310 or reminder 1330. If the present invention can find a correlation through an online search between either the user information or the reminder and the proposed answer, the proposed answer should be rejected. The online search may be performed, for example, using a search engine, such as Google.com.

As with any online search, the accuracy of the authentication information security analysis process 1700 is impaired by false hits (i.e., unrelated results) in the results of the query. The false hits cause the authentication information security analysis process 1700 to unnecessarily reject reasonable query based passwords. The security assessment of the present invention can be improved by using meta-searching, local proximity techniques, number classification or a combination of the foregoing to reduce the number of false hits.

A meta-search engine may optionally be employed to reduce the number of false hits. A meta-search employs a number of search engines in parallel and compares the results from each search engine. Generally, the more search engines a given web page gets a hit from, the more reliable the web page will be in terms of carrying the user information. An exemplary meta-search engine is Dogpile.com that provides a collection of 16 search engines, such as Google, Overture, Ask Jeeves, and About. While Google is generally perceived to retrieve the most relevant results, the meta search engine helps to reduce the number of false hits.

Local proximity techniques can optionally be employed to reduce the number of false hits. Local proximity techniques can be employed to ensure that the hits from a search are in the proper context. For example, local proximity techniques can be employed to ensure that search results corresponding to a proposed telephone number are actually telephone numbers. A telephone number is typically comprised of an area code (first three digits), a prefix (next three digits) and a telephone number portion (last four digits). The area code, prefix and telephone number should be treated as separate tokens in the query to cover the various potential formats of a telephone number. For example, a web page that contains “212.998.3365” will be missed by a query specified as “212-998-3365” (for exact phrase match). However, if the various components are searched separately, each set of digits must be sufficiently close to each other to conform to a telephone number. False hits will occur when the numbers occur separately within the same page. In one implementation, the local proximity technique can calculate a minimum average distance of the numbers and reject a given web page if the average distance is greater than a defined threshold.

Number classification techniques can also optionally be employed to reduce the number of false hits. Number classification techniques can be employed to ensure that the hits from a search are due to the proper type of numbers (or other information). For example, in the exemplary telephone number implementation, the number classification techniques can be employed to ensure that the hits from a search are due to telephone numbers. The present invention recognizes that the numbers (area code, prefix, telephone number) hit by mistake tend to have a different usage, such as publication page numbers, identification numbers or portions thereof, or dates.

The automatic prediction of the usage of numbers can be used as a criteria for filtering the search results. In one exemplary implementation, number classification techniques are employed to distinguish between telephone numbers and non-phone numbers (such as addresses, publication pages or dates).

FIG. 18 is a sample table from an exemplary authentication information security analysis rule-base 1800. As shown in FIG. 18, the exemplary authentication information security analysis rule-base 1800 includes a plurality of rows 1810-1820, each associated with a different rule. For each rule, identified by a rule name in field 1830, the authentication information security analysis rule-base 1800 indicates the type of rule in field 1840, e.g., self association, hint association or commonality rule, and the rule conditions in field 1850. As described above in conjunction with FIG. 17, the exemplary rules in the authentication information security analysis rule-base 1800 are tested by the authentication information security analysis process 1700.

For example, the “user telephone number” rule associated with record 1810 determines whether the user is the record owner of the proposed telephone number. The “word association” rule associated with record 1811 determines whether the user is strongly associated with a word that is presented as the proposed password. The “word association” rule recognizes that some words are easily attacked. For example, Author A may have written a book about compilers, Author B may have written a book containing “programming pearls” and Author C may have written a book (or work in an area) about image analysis. Thus, for each author, a search engine may identify the word counts 1900 for certain words, as shown in FIG. 19. Thus, certain words are highly correlated with certain users. For example, for Author A, there is a high correlation with the word “compilers” that is not found for authors B or C. Thus, the word “compiler” should not be allowed for author A. The word association rule can employ a percentage cutoff (e.g., if the word count exceeds X %, the word may not be employed as a password) or employ tests based on statistical significance.

The “Hint Related to User” rule associated with record 1812 determines whether the person associated with a proposed hint is in a particular relation with the user. For example, the “Hint Related to User” rule may determine if there is a predefined relationship between the owner of the telephone number and the user, such as a family member (self, sibling or parent), co-author, colleague or member of the same household. If so, this telephone number is said to be correlated with the user and is disallowed as an answer. The “Hint Related to User” rule 1812 can also encompass relationships that are detected indirectly. For example, a query based on the hint and user information may reveal that the hint is a childhood friend of the user. A threshold can be defined based on the number of associations between the user and the name associated with the hint.

The Common Telephone Number rule associated with record 1820 determines whether a popular business entity is the owner of a proposed telephone number. If so, this telephone number is said to be too easily guessed and is disallowed as an answer. It is noted that an attacker may always try the “top N” most popular telephone numbers for every user, and these numbers should be excluded as passwords. Additional commonality rules can assess whether the names used as proposed passwords are too common. For example, a name can be analyzed to determine how common a name is in general and/or in a given context. It is noted that a name such as “Smith” may be more common than “Singh” in some places, but the opposite is true in other places. In addition, commonality rules can assess whether the association between a proposed hint and password is too strong. For example, a search engine may indicate that the word count (in thousands) for “Columbus” and “1492” may be very high, relative to other potential years (any year other than 1492). Similar searches can be created to search for other popular associations, including common telephone numbers, historical dates, jersey numbers for athletes and text (e.g., for the proposed hint “first president” and password “GeorgeWashington”).

Finally, the search results for the user information 1310, proposed answer 1320 and proposed hint 1330 can be used to assign a security score to the proposed password, such as the hint/answer pair in a query based password implementation. For example, the search performed for the “word association” rule can be easily extended to assess a score for the (user, keyword) pairs. Similarly, a low security score can be assessed to common names, while higher scores can be assessed to names that are determined to be more rare. A threshold can optionally be assigned to determine whether the determined security score is sufficient to accept a proposed password.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention. For example, while the invention has been illustrated using telephone numbers as query based passwords, the authentication information might also be, for example, personal identification numbers (PINs) or other passwords based on dates or street addresses (including Zip codes and post office boxes).

In a date implementation, the proposed dates can be evaluated for relation to general, well-known dates, such as Jul. 4, 1776 (741776) or obtainable user-related dates, such as birthdays or anniversaries. To improve the search results for passwords based on dates, a date classification scheme can be employed, in a similar manner to the telephone number scheme described above.

In a street address implementation, the proposed addresses (or portions thereof) can be evaluated for relation to general, well-known addresses, such as The White House, 1600 Pennsylvania Avenue NW, Washington, D.C. 20500, or obtainable user-related addresses, such as address of home or business. To improve the search results for passwords based on addresses, an address classification scheme can be employed, in a similar manner to the telephone number scheme described above.

1. A method for evaluating a password proposed by a user, comprising:
receiving said proposed password from said user; and
ensuring that a correlation between said user and said proposed password does not violate one or more predefined correlation rules.

2. The method of claim 1, wherein said one or more predefined correlation rules evaluate whether that said proposed password can be qualitatively correlated with said user.

3. The method of claim 1, wherein said one or more predefined correlation rules evaluate whether said proposed password can be quantitatively correlated with said user.

4. The method of claim 1, wherein said proposed password is comprised of a proposed answer and a proposed hint and wherein said one or more predefined correlation rules evaluate whether said proposed answer can be correlated with said proposed hint in a particular relation.

5. The method of claim 4, wherein said particular relation is selected from the group consisting essentially of: self, family member, co-author, teammate, colleague, neighbor, community member or household member.

6. The method of claim 1, wherein said proposed password is comprised of a proposed answer and a proposed hint and wherein said one or more predefined correlation rules evaluate whether said proposed answer can be obtained from said proposed hint.

7. The method of claim 1, wherein said proposed password is an identifying number.

8. The method of claim 7, wherein said one or more predefined correlation rules evaluate whether said identifying number identifies a person in a particular relationship to said user.

9. The method of claim 7, wherein said one or more predefined correlation rules evaluate whether said identifying number is a top N most commonly used identifying number.

10. The method of claim 7, wherein said one or more predefined correlation rules evaluate whether said identifying number identifies a top N commercial entity.

11. The method of claim 7, wherein said one or more predefined correlation rules evaluate whether said identifying number identifies said user.

12. The method of claim 7, wherein said identifying number is a portion of a telephone number.

13. The method of claim 7, wherein said identifying number is a portion of an address.

14. The method of claim 7, wherein said identifying number is a portion of social security number.

15. The method of claim 1, wherein said proposed password is a word.

16. The method of claim 15, wherein said one or more predefined correlation rules evaluate whether a correlation between said word and said user exceeds a predefined threshold.

17. The method of claim 1, wherein said correlation is determined by performing a meta-search.

18. The method of claim 1, wherein said step of ensuring a correlation further comprises the step of performing a meta-search.

19. The method of claim 1, wherein said step of ensuring a correlation further comprises the step of performing a local proximity evaluation.

20. The method of claim 1, wherein said step of ensuring a correlation further comprises the step of performing a number classification.

21. An apparatus for evaluating a password proposed by a user, comprising:
a memory; and
at least one processor, coupled to the memory, operative to:
receive said proposed password from said user; and
evaluate whether a correlation between said user and said proposed password violates one or more predefined correlation rules.

22. The apparatus of claim 21, wherein said one or more predefined correlation rules evaluate whether said proposed password can be correlated with said user.

23. The apparatus of claim 21, wherein said proposed password is comprised of a proposed answer and a proposed hint and wherein said one or more predefined correlation rules evaluate whether said proposed answer can be correlated with said proposed hint in a particular relation.

24. The apparatus of claim 21, wherein said proposed password is comprised of a proposed answer and a proposed hint and wherein said one or more predefined correlation rules evaluate whether said proposed answer can be obtained from said proposed hint.

25. The apparatus of claim 21, wherein said proposed password is an identifying number.

26. The apparatus of claim 25, wherein said one or more predefined correlation rules evaluate whether said identifying number identifies a person in a particular relationship to said user.

27. An article of manufacture for evaluating a password proposed by a user, comprising a machine readable medium containing one or more programs which when executed implement the steps of:
receive said proposed password from said user; and
evaluate whether a correlation between said user and said proposed password violates one or more predefined correlation rules.
